(19) United States
(12) Patent Application Publication
(10) Pub. No.: US 2012/0258018 A1
(43) Pub. Date: Oct. 11, 2012

(54) SUBSTRATE PROCESSING APPARATUS, AND TRANSPORT DEVICE

(75) Inventors: Eisuke NISHITANI, Toyama-City (JP); Yasuo KUNII, Takasaki-city (JP); Kazuyuki TOYODA, Toyama-city (JP); Hidenari YOSHIDA, Tayama-city (JP); Mitsunori ISHISAKA, Namerikawor-city (JP)

(73) Assignee: HITACHI KOKUSAI ELECTRIC INC., Tokyo (JP)

(21) Appl. No.: 13/427,304

(22) Filed: Mar. 22, 2012

(30) Foreign Application Priority Data
Apr. 8, 2011 (JP) 2011-086641

(51) Int. Cl. B01J 19/24

(52) U.S. Cl. 422/198

(57) ABSTRACT

There is provided a substrate procession apparatus, comprising: a processing chamber configured to house a plurality of substrates with a laminated film formed thereon which is composed of any one of copper-indium, copper-gallium, or copper-indium-gallium; a reaction tube formed so as to constitute the processing chamber; a gas supply tube configured to introduce elemental selenium-containing gas or elemental sulfur-containing gas to the processing chamber; an exhaust tube configured to exhaust an atmosphere in the processing chamber; heating section provided so as to surround the reaction tube; and a fan configured to forcibly circulate the atmosphere in the processing chamber in a short-side direction of the plurality of glass substrates, on surfaces of the plurality of glass substrates.

### TECHNICAL FIELD

The present invention relates to a substrate processing apparatus, and a transport device, and particularly relates to the substrate processing apparatus and the transport device for forming an optical absorption layer of selenide-based CIS solar battery.

### DESCRIPTION OF RELATED ART

The selenide-based CIS solar battery has a structure of sequential lamination of a glass substrate, a metal rear surface electrode layer, a CIS light absorbing layer, a high resistance buffer layer, and a window layer. Wherein, the CIS light absorbing layer is formed by selenization of any one of the lamination structures of copper (Cu)/gallium (Ga), Cu/indium (In), or Cu—Ga/In. Thus, the selenide-based CIS solar battery can be formed without using silicon (Si), and therefore a substrate can be made thin and a manufacturing cost can be reduced.

Here, patent document 1 can be given as an example of a device that carries out selenization treatment. A selenization device described in patent document 1 applies selenization treatment to an object by arranging a plurality of flat plate-like objects by a holder at constant intervals in parallel to a longitudinal axis of a cylindrical quartz chamber with its surface level vertical to the objects, to thereby apply selenization treatment to the objects by introducing a selenium source. Further, according to patent document 1, by disposing a fan on an end in an axial direction of the cylindrical quartz chamber, the selenium source in the quartz chamber is forcibly circulated to achieve a uniform temperature distribution on the glass substrate.

Patent document 1:

### Japanese Patent Laid Open Publication No. 2006-186114

### SUMMARY OF THE INVENTION

When the fan is disposed on the end in the axial direction of the cylindrical quartz chamber as described in patent document 1, an atmosphere in the quartz chamber circulates horizontally in the quartz chamber, namely circulates in a long-side direction of the glass substrate. Wherein, if the size of the glass substrate is increased for reducing the manufacturing cost of the CIS solar battery, the long-side of the glass substrate is also increased. Accordingly, in order to keep a uniform temperature on the surface of the glass substrate during increase/decrease of the temperature, a flow velocity of the circulating gas needs to be increased or the increasing/decreasing speed of the temperature needs to be slow. In the former case, a performance of the fan needs to be high, resulting in an expensive fan. In addition, there is a limit in the performance of the fan, thereby making it difficult to be realized. Further, if the gas circulates through a narrow space between glass substrates with high velocity, a force to attract the glass substrate is increased, thus possibly shaking the glass substrate. As a result, there is a problem that the glass substrate and a holder are rubbed against each other, to thereby generate particles. Meanwhile, if the velocity of the increase/decrease of the temperature is set to be small, a processing time is prolonged, thus reducing a throughput and increasing the manufacturing cost. Accordingly, the size of the glass substrate is hardly increased.

Further, a weight is also increased by increasing the size of the glass substrate, thus making it difficult to load a plurality of glass substrates into the quartz chamber.

According to a preferable aspect of the present invention, there is provided a substrate processing apparatus, comprising:

a processing chamber in which a plurality of substrates are housed, each of the plurality of substrates having a laminated film which is composed of any one of copper-indium, copper-gallium, or copper-indium-gallium;

a reaction tube formed in such a manner as constituting the processing chamber;

a gas supply tube configured to introduce elemental selenium-containing gas or elemental sulfur-containing gas into the processing chamber;

an exhaust tube configured to exhaust an atmosphere in the processing chamber;

a heating section provided to surround the reaction tube; and

a fan configured to forcibly circulate the atmosphere in the processing chamber in short-side direction of the plurality of glass substrates.

According to other preferable aspect of the present invention, there is provided a transport device that transports a cassette for holding a plurality of substrates into a processing chamber, comprising: a support section configured to support the cassette;

a wheel section fixed to the support section; and

an arm configured to integrally operate the support section and the wheel section.

According to the present invention, the manufacturing cost can be reduced.

### BRIEF DESCRIPTION OF THE DRAWINGS

FIG. 1 is aside cross-sectional view of a processing furnace according to a first embodiment of the present invention.

FIG. 2 is a cross-sectional view of the processing furnace viewed form a left direction on the paper of FIG. 1.

FIG. 3 is a perspective view of a cassette 410 according to the present invention.

FIG. 4 is a view for describing a coating film of the present invention.

FIG. 5 is a view for describing a state that the cassette 410 of the present invention is transported.

FIG. 6 is a view for describing a transport device 600 of the present invention.

FIG. 7 is a view showing a result of a simulation for describing an effect of the present invention.

FIG. 8 is a view showing a structure of a model of other simulation for describing the effect of the present invention.

FIG. 9 is a view showing a result of other simulation for describing the effect of the present invention.

FIG. 10 is a view showing the result of other simulation for describing the effect of the present invention.

FIG. 11 is a side cross-sectional view of a processing furnace according to a second embodiment of the present invention.

### DETAILED DESCRIPTION OF THE INVENTION

### First Embodiment

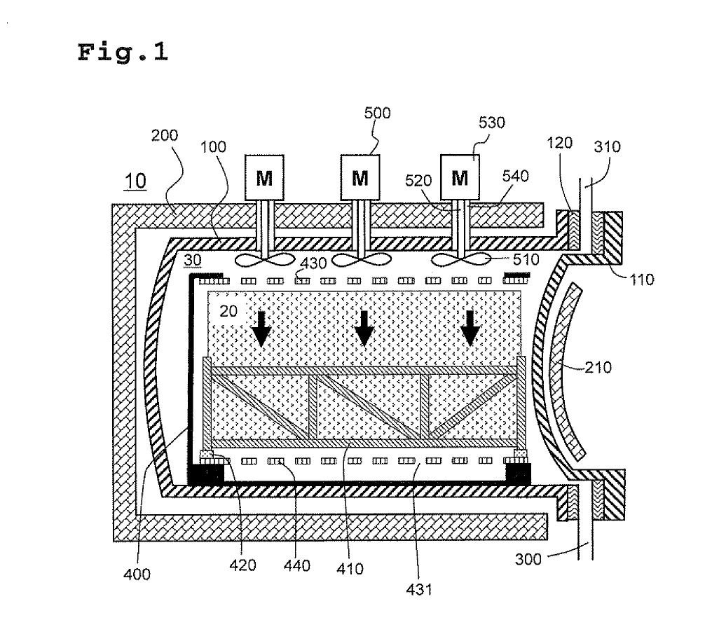

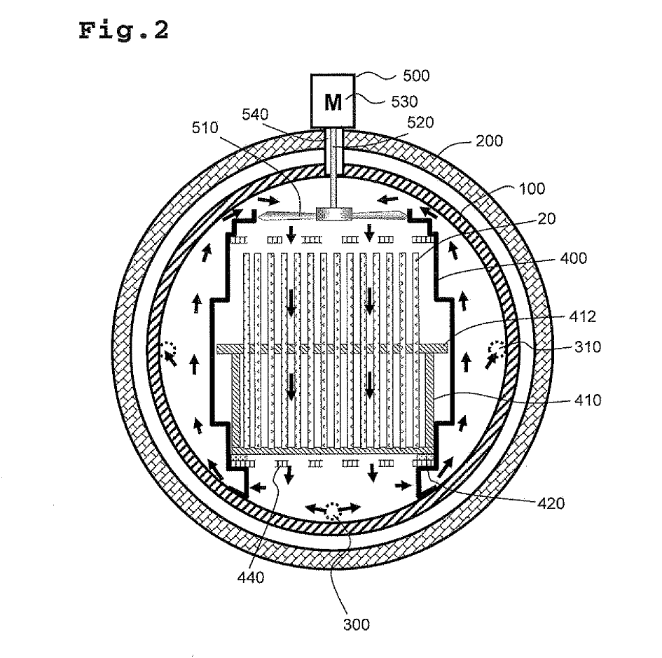

A first embodiment of the present invention will be described hereafter, with reference to the drawings. FIG. 1 is a side cross-sectional view of a processing furnace 10 assembled into a substrate processing apparatus that performs selenization treatment according to the present invention. Further, FIG. 2 is a cross-sectional view of the processing furnace viewed from a left side on the paper of FIG. 1.

The processing furnace 10 has a reaction tube 100, being a furnace body, made of a metal material such as stainless. By using the metal material such as stainless, processing is more facilitated than using a quarts material, and the size of the reaction tube 100 is easily increased. The reaction tube 100 has a hollow cylindrical shape, with its one end closed and the other end opened. A processing chamber 30 is formed by the hollow portion of the reaction tube 100. A cylindrical shaped manifold 120 with its both ends opened, is provided concentrically with the reaction tube 100, on the opening part side of the reaction tube 100. An O-ring (not shown), being a seal member, is provided between the reaction tube 100 and the manifold 120.

A movable seal cap 110 is provided in the opening part of the manifold 120 where the reaction tube 100 is not provided. The seal cap 110 is made of a metal material such as stainless, and has a projection shape so as to be partially inserted into the opening part of the manifold 120. The O-ring, being the seal member, (not shown) is provided between the movable seal cap 110 and the manifold 120, and when the processing is performed, the seal cap 110 air-tightly closes the opening part side of the reaction tube 100.

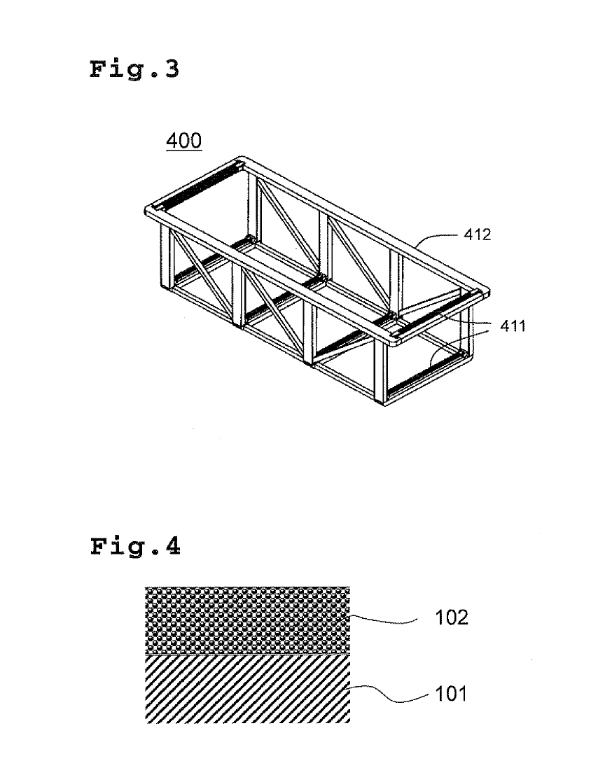

An inner wall 400 is provided inside the reaction tube 100, for placing a cassette 410 which holds a plurality of glass substrates (for example 30 to 40 glass substrates) with a laminated film formed thereon composed of copper (Cu), indium (In), and gallium (Ga). As shown in FIG. 2, the inner wall 400 is formed so that one end thereof is fixed to an inner peripheral surface of the reaction tube 100, and the cassette 410 is placed in the center of the reaction tube 100 via an installation base 420. The inner wall 400 is formed so that a pair of members provided in such a manner as interposing the cassette 410 between them, are connected to each other at both ends, thus increasing the strength thereof. As shown in FIG. 1, the cassette 410 holds a plurality of glass substrates 20 arranged in a horizontal direction and in an upright state. Further, as shown in FIG. 3, the cassette 410 is formed in a framework of forming a rectangular parallelepiped. The cassette 410 has holding members 411 for holding the glass substrates 20. The holding members 411 are provided at both ends in a long-side direction of the rectangular parallelepiped of the cassette 410, and in a lower part of the framework of the rectangular parallelepiped. Further, a collar section 412 is provided on the upper side in the long-side direction of the cassette 410 so as to be protruded to outside from the rectangular parallelepiped (see FIG. 2). As will be described later, the collar section 412 is used for loading and unloading the cassette 410. Note that the center of the inner wall 400 is formed in a projection shape so that the collar section 412 can be stored therein.

Further, a furnace heating section 200 having a hollow cylindrical shape is provided, with one end closed and the other end opened to surround the reaction tube 100. Further, a cap heating section 210 is provided on a side face opposite to the reaction tube 100 of the seal cap 110. Inside of the processing chamber 30 is heated by the furnace heating section 200 and the cap heating section 210. Note that the furnace heating section 200 is fixed to the reaction tube 100 by a fixing member not shown, and the cap heating section 210 is fixed to the seal cap 110 by the fixing member not shown. Further, a cooling unit such as a water cooling unit not shown is provided in the seal cap 110 and the manifold 120, for protecting the O-ring having low heat resistance.

A gas supply tube 300 is provided in the manifold 120, for supplying selenium hydride (“H₂Se” hereafter), being elemental selenium-containing gas (selenium source). H₂Se supplied from the gas supply tube 300 is supplied to the processing chamber 30 via a space between the manifold 120 and the seal cap 110. Further, an exhaust tube 310 is provided at a different position from the gas supply tube 300 of the manifold 120. The atmosphere in the processing chamber 30 is exhausted from the exhaust tube 310 via the space between the manifold 120 and the seal cap 110. Note that if a cooling spot is cooled to 150° C. or less by the aforementioned cooling unit, unreacted selenium is condensed at this spot, and therefore temperature maybe controlled from about 150° C. to 170° C.

The reaction tube 100 is made of the metal material such as stainless. The metal material such as stainless is easy to be processed, compared with quartz. Therefore, A large-sized reaction tube 100 used for the substrate processing apparatus that applies selenization treatment to the CIS solar battery, can be easily manufactured. The number of the glass substrates that can be housed in the reaction tube 100 can be increased, and therefore the manufacturing cost of the CIS solar battery can be reduced.

A plurality of electric fans 500 are provided along the long-side direction of the glass substrate, on the upper side of the processing furnace 10. Each of the plurality of electric fans 500 has: a blade section 510 configured to form a circulation in the processing chamber 30 by rotating; a rotating shaft 520 provided to penetrate a side wall of the cylindrical tube 100 and a side wall of a furnace heating section 200; and a power transmitting section 530 provided outside the furnace heating section 200 and configured to rotate the rotating shaft 520. Further, a protective member 540 is provided between the rotating shaft 520 and the reaction tube 100, and between the rotating shaft 520 and the furnace heating section 200, thus preventing reaction gas from invading into the power transmitting section 530 from the rotating shaft 520, by carrying out nitrogen purge in the space between the protective member 540 and the rotating shaft 520.

The flow of the gas in a short-side direction of the glass substrate 20 is formed in the processing chamber 30, by the plurality of electric fans 500. Thus, the flow velocity of the gas required for obtaining a uniform temperature on the glass substrate 20 can be decreased by operating the electric fan 500 to thereby forcibly circulate the gas toward the short-side direction of the glass substrate.

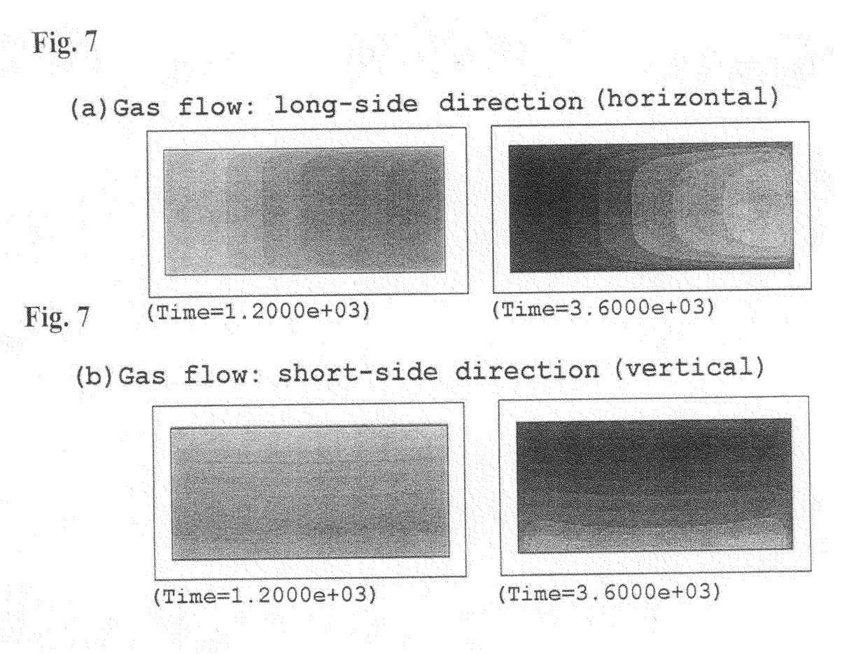

FIG. 7 shows a result of simulating the flow velocity required for suppressing a temperature difference in the surface of the glass substrate to about 30° C. excluding the position of the electric fan, by varying the flow velocity between the glass substrates in a case that the temperature is increased at a rate of 5° C./minute in the processing furnace with the same structure. FIG. 7A shows a result in a case that the electric fan is disposed on the side face of the processing furnace, and the flow of the gas on the surface of the glass substrate is formed in the long-side direction of the glass substrate, and the flow velocity of the gas is 10 m/second, which is required for suppressing the temperature difference in the surface of the glass substrate to about 30° C. FIG. 7B shows a result in a case that the electric fan is disposed on an upper surface of the processing furnace, and the flow of the gas on the surface of the glass substrate is directed to the short-side direction of the glass substrate, and the flow velocity of the gas is 2 m/second, which is required for suppressing the temperature difference in the surface of the glass substrate to about 30° C. Note that the left sides of FIG. 7A and FIG. 7B show a state after 20 minutes of heating (400K=123° C.), and the right sides thereof show a state after heating of 60 minutes (600K=323° C.). As is clarified from the result of FIG. 7, the flow velocity of the gas can be suppressed by directing the flow of the gas to the short-side direction of the glass substrate as shown in this embodiment, so that the size of the glass substrate can be increased.

As shown in FIG. 2, the gas passing through the surface of the glass substrate 20 returns to the upper part along the inner wall of the reaction tube 100. Accordingly, the atmosphere in the processing chamber 30 is circulated. Further, by forming the inner walls 400 so as to interpose the side portion of the electric fan 500 between them, a forcibly circulated gas flow by the electric fan 500 can be directed to the glass substrate 20. Further, by providing a plurality of electric fans 500 in the long-side direction of the glass substrate, uniformity of the gas in the long-side direction can be improved.

The processing furnace 10 has a first rectifier 430 being a plate-shaped member having a plurality of opening parts 431 fixed to the inner wall 400, on the upstream side of the gas of the glass substrate 20. Numerical aperture of each opening part 431 of the first rectifier 430 is adjusted, and a conductance of the gas is adjusted, to thereby further uniformly flow the gas on the surface of a plurality of glass substrates 20. Particularly, in this embodiment, a plurality of electric fans 500 are arranged in the long-side direction, and therefore there is a possibility that different flows of the gas are formed in the area immediately under the electric fans 500, and in the space between electric fans 500. In this case, the gas can be uniformly flowed, by differentiating the numerical apertures in the area immediately under the electric fan 500, and in the space between electric fans 500, and by adjusting the conductance of the gas. Note that FIG. 2 shows a case that the opening part 431 is formed so that one opening part 431 is provided to a plurality of glass substrates 20. However, the embodiment is not limited thereto, and it is also acceptable that one opening part 431 is provided corresponding to one space between the glass substrates 20.

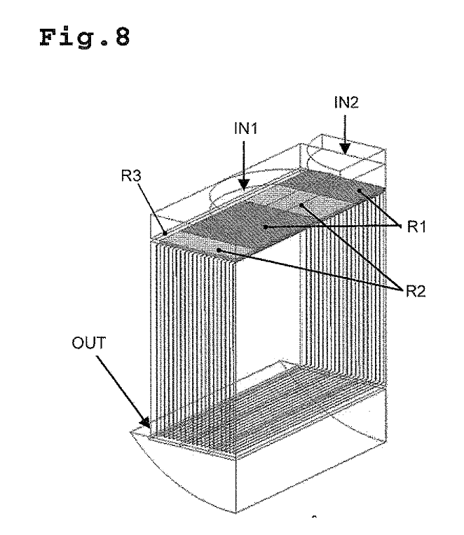

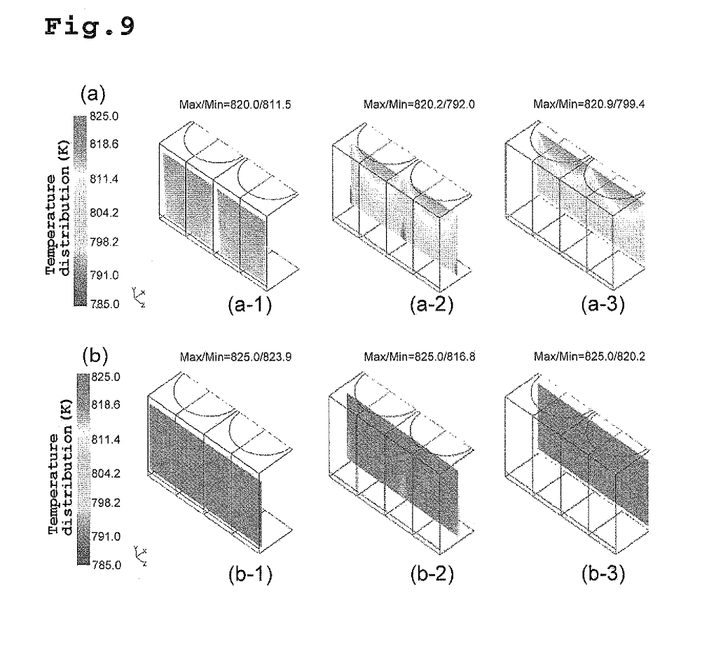

FIG. 8 shows a block diagram in a case of simulating an effect of the first rectifier 430 having areas with different numerical apertures. This simulation uses a model of the length equal to half of 20 glass substrates obtained by dividing 40 glass substrates by a symmetry plane (¼ symmetrical model). Further, a first inflow port IN1 and a second inflow port IN2 are formed corresponding to the electric fan 500 so that the gas of 12 m³/minute is supplied from the first inlet port INI and the gas of 6 m³/minute is supplied from the second inlet port IN2, which are then flow out from an outflow port OUT. Further, resistances of the gas flow are provided in areas R1, R2, R3 corresponding to the first rectifier 430. Specifically, the numerical aperture of the area RI corresponding to the area immediately under the electric fan is set to 40%, and the numerical aperture of the area R2 corresponding to the area between the electric fans is set to 30%. Further, although not shown, area R3 of the end of an arranging direction of a plurality of glass substrates, is set so that the gas does not flow out to the outside.

Thus, by squeezing an amount of gas flowing to the end of the arranging direction of a plurality of glass substrates, by suppressing the gas flow velocity immediately under the electric fan, and by suppressing the decrease of the flow velocity due to a confluence of a plurality of electric fans, the result can be obtained as follows. Namely, an average gas flow velocity between the glass substrates is 2 m/second or more, and a lowest gas flow rate between the glass substrates is 1.2 m/second or more, when a total circulated gas flow rate is set to 72 m³/minute.

FIG. 9 shows a result of a simulation regarding a temperature deviation (ΔT) in the surface of the glass substrate, which is generated in a case that the glass substrate is heated under a similar condition of the gas flow velocity, in the structure similar to the structure of FIG. 8. Note that in this simulation, the simulation is carried out using not the ¼ symmetrical model of FIG. 8, but using a length of two arranged electric fans in the long-side direction of the glass substrate. FIG. 9A shows a temperature distribution at 550° C. (823K) after 1 hour and 45 minutes where the temperature deviation (ΔT) becomes maximum, by increasing the temperature at a rate of 5° C./minute and by starting the heating from a room temperature (25° C.) Further, (a-1) indicates the vicinity of a first glass substrate from the end, (a-2) indicates 11-th glass substrate from the end, and (a-3) indicates 20-th glass substrate from the end (center), and the numeral described in the upper part thereof show a minimum temperature and a maximum temperature in the surface of the glass substrate. It is found that the temperature is lowest on the end between both ends and the center of the 40 glasses or on the downstream portion between two electric fans in the vicinity of 11-th glass substrate. However, deviation (ΔT) of 28° C. is observed in a state that the whole body of the glass is heated to about 550° C., which is a sufficiently allowable range. Further, FIG. 9B shows a temperature deviation (ΔT) after elapse of about 10 minutes, with a furnace temperature fixed to 552° C. (825K) from FIG. 9A. Similarly to FIG. 9A, (b-1) indicates the vicinity of first glass substrate from the end, (b-2) indicates the vicinity of the 11-th glass substrate, and (b-3) indicates the vicinity of the 20-th glass substrate (center) from the end, and the maximum temperature and the minimum temperature in the surface are shown in the upper part thereof. As is clarified from FIG. 9B, it is found that sufficient temperature uniformity can be maintained during the process (when the temperature is stable).

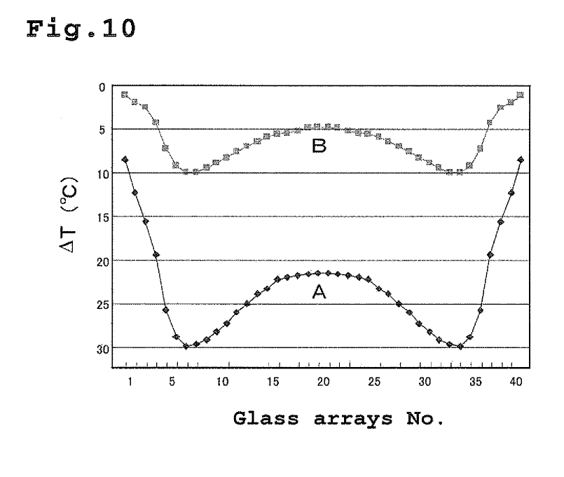

FIG. 9 shows the in-surface temperature distribution of the glass in the vicinity of the first glass, in the vicinity of the 11-glass, and in the vicinity of the center from the end. However, FIG. 10 shows a state that the maximum temperature difference in the surface of the glass substrate generated during heating in the furnace is plotted for all 40 glass substrates. “A” indicates the temperature deviation (corresponding to FIG. 9A) during heating to 550° C., and “B” indicates the temperature deviation (FIG. 9B) after elapse of 10 minutes after circulating the gas while maintaining the temperature of the gas at 552° C. after the temperature reaches 552° C. Although relatively large temperature deviation is generated between 6-th and 8-th glass substrates from the end under influence of two fans, extremely excellent uniformity of the temperature within 30° C. during heating, and within 10° C. during the process, can be realized by adjusting the conductance using a rectifier, etc.

Note that this simulation is carried out by setting the numerical aperture of the area immediately under the electric fan to be higher than the numerical aperture of the area between electric fans. However, the simulation is not limited thereto, and an opposite relation of the numerical apertures is sometimes desirable, depending on the structure of a reaction furnace. However, the condition of the gas flow is different between the area immediately under the electric fan, and the area between the electric fans, and therefore the conductance of the gas flow can be adjusted and the uniformity can be improved by different numerical apertures in the area immediately under the electric fan and the in the area between the electric fans as described in this embodiment.

Further, the processing furnace 10 has a second rectifier 440, being a plate-shaped member, having a plurality of opening parts 431 fixed to the inner wall 400, on the downstream side of the glass substrate 20. By having the second rectifier on the downstream side, in addition to the first rectifier on the upstream side, a factor of adjusting the uniformity of the gas can be increased, and uniform flow of the gas can be easily obtained. Note that FIG. 2 shows a case that the opening part 431 is formed so that one opening part 431 is provided to a plurality of glass substrates 20. However, the embodiment is not limited thereto, and it is also acceptable that one opening part 431 is provided corresponding to one space between the glass substrates 20.

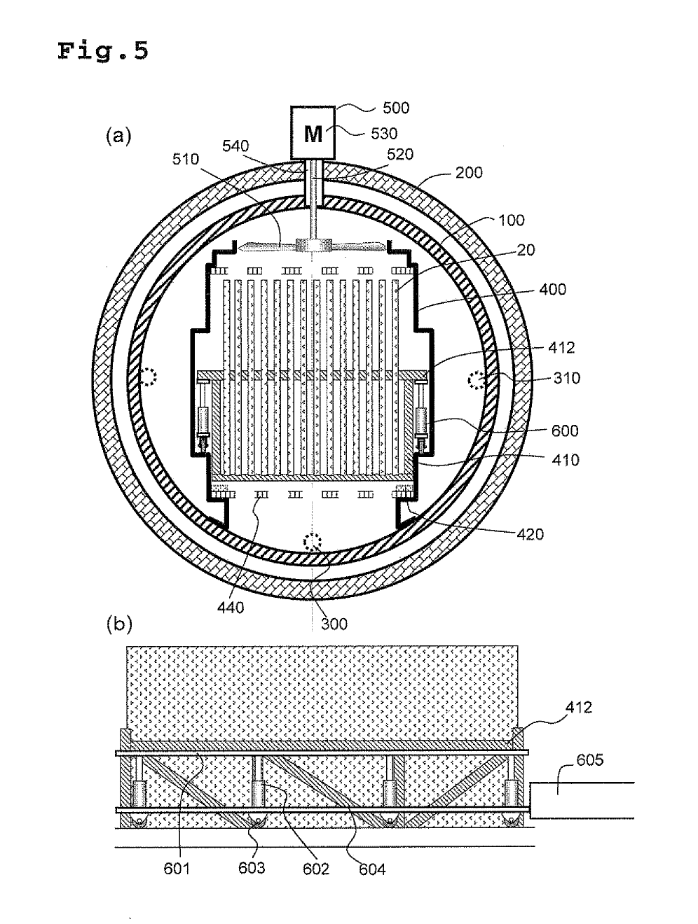

Further, at least the surface of the reaction tube 100 exposed to the atmosphere in the processing chamber 30, and at least the blade section 510 and the rotating shaft 520 of the electric fan 500, are coated with a coating film formed on the metal material such as stainless, being a base 101, as shown in FIG. 4, with high selenization resistance compared with the metal material such as stainless. Corrosion of the metal material such stainless occurs by being brought into contact with an extremely highly reactive gas such as H₂Se heated to 200° C. or more. However, by forming the coating film with high selenization resistance like this embodiment, the corrosion by the gas such as H₂Se can be suppressed, and therefore the generally used metal material such as stainless can be used. Thus, the manufacturing cost of the substrate processing apparatus can be reduced. Note that the coating film mainly composed of ceramic is preferable as the coating film with high selenization resistance, and chromium oxide (CrₓO_{y}:x, y are arbitrary number of 1 or more), alumina (AlxOy:x, y are arbitrary number of 1 or more), silica (SixOy:x, y are arbitrary number of 1 or more) alone respectively or a mixture of them, can be given for example.

Further, a coating film 102 of this embodiment is formed by a porous film. Thus, thermal expansion/contraction can be flexibly coped with, which is caused by a difference of coefficient of linear expansion between the base 101 formed by the metal material such as stainless and the coating film 102. As a result, even if heat treatment is repeatedly performed, generation of a crack on the coating film can be suppressed to minimum. Note that the coating film 102 is desirably formed in a thickness of 2 to 200 μm, and more preferably 50 to 120 μm. Further, deviation of the coefficient of linear expansion between the base 101 and the coating film 102 is preferably 20% or less, and more preferably 5% or less.

Further, the aforementioned coating film may also be similarly formed on a part of the seal cap 110, the manifold 120, the gas supply tube 300, and the exhaust tube 310 exposed to a selenium source. However, coating may not be applied to a part cooled to 200° C. or less by a cooling unit for protecting the O-ring, etc., because the metal material such as stainless is not reacted even if it is brought into contact with the selenium source.

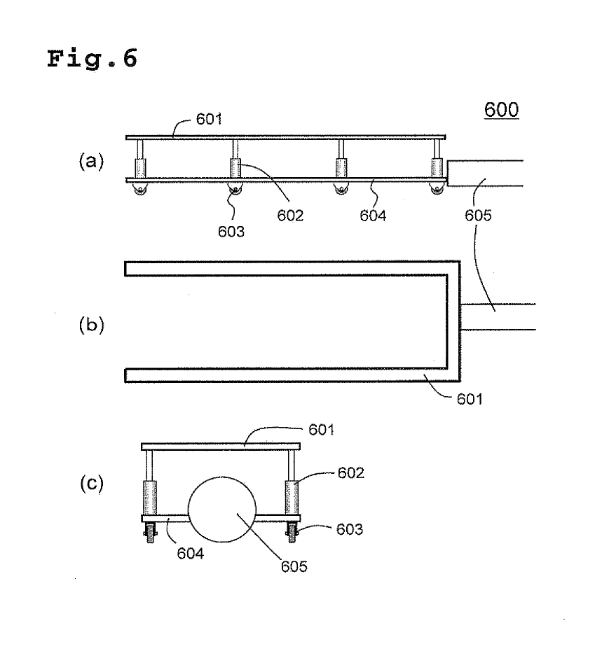

Loading and unloading of the cassette 410 into/from the processing chamber 30 will be described next. FIG. 5 shows a state of loading or unloading of the cassette 410, wherein FIG. 5A is a cross-sectional view corresponding to FIG. 2, and FIG. 5B is a view when the processing furnace is viewed from a side face, and only a portion required for explanation is shown. Further, FIG. 6 is a view of extracting the transport device of the present invention, wherein FIG. 6A is a side view, and FIG. 6B is an upper side view, and FIG. 6C is a view of the transport device 600 viewed from backside.

If the size of the glass substrate 20 is increased, the weight of the cassette 410 is also increased. Therefore, it becomes difficult to lift the cassette 410 by inserting a plate-shaped member under the cassette 410. Therefore, in this embodiment, the collar section 412 is provided to the cassette 410, and the cassette 410 is transported by the transport device 600 with wheels capable of lifting the collar section 412. The transport device 600 has a support section 601 that supports the collar section 412; a plurality of elevating/lowering sections 602 that elevate and lower the support section 601; a plurality of wheel sections 603 provided under the elevating/lowering sections; a fixing member 604 capable of integrally operating the plurality of elevating/lowering sections 602 and the plurality of wheel sections 603; and an arm 605 provided to the fixing section. As shown in FIG. 6, right and left elevating/lowering sections 602 and wheel sections 603 are configured to be integrally operated by the support section 601 and the fixing member 604, and by moving the arm 605 back and forth, the whole body of the transport device 600 can be integrally moved.

When the cassette 410 is transported, the support section 601 is elevated by the elevating/lowering section 602, and the whole body of the cassette 410 is lifted by lifting the collar section 412. As a result, the cassette 410 can be moved without being brought into contact with the installation base 420. Further, since the cassette 410 is supported by the plurality of wheel sections 603, load can be dispersed even if the weight of the cassette 410 is increased, and therefore heavier cassette 410 can be transported. Moreover, the inner wall 400 has a projection part (transport path) protruded to outside so that the plurality of wheel sections 603 can be moved. Accordingly, the wheel sections 603 move on the transport path of the inner wall 400 by moving the arm 605 back and forth, so that the cassette 410 can be smoothly transported.

Further, after the cassette 410 is loaded up to a prescribed position, the support section 601 is lowered by the elevating/lowering section 602. Although the cassette 410 is lowered following the lowering of the support section 601, it is not lowered below the installation base 420 when a lower surface of the cassette 410 is brought into contact with the installation base 420. When the support section 601 is further lowered by the elevating/lowering section 602, the support section 601 and the collar section 412 are separated from each other because the cassette 410 is not lowered below the installation base 420. As a result, by retreating the arm 605, the transport device 600 can be taken out from the processing chamber 30 in a state that the cassette 410 is placed in the processing chamber 30. In a case that the cassette 410 is unloaded, an opposite procedure may be used.

Thus, a larger size of the glass substrate 20 can be coped with, by lifting and moving the cassette 410 by the transport device 600 having the support section 601 and a plurality of wheel sections 603. Further, the cassette 410 and the transport device 600 can be separated from each other by providing the elevating/lowering section 602 capable of elevating/lowering the support section 601, and only the transport device 600 can be loaded and unloaded into/from the processing chamber 30.

Next, explanation will be given for a method for manufacturing a substrate, being a part of a method for manufacturing the CIS solar battery, performed using the processing furnace of this embodiment.

First, 30 to 40 glass substrates with a laminated film formed thereon composed of copper (Cu), indium (In), and gallium (Ga), are prepared in the cassette 410. Next, the collar section 412 of the cassette 410 is lifted by the support section 601 of the transport device 600. Thus, the cassette 410 can be moved. Thereafter, the wheel section 603 of the transport device 600 is placed on the transport path of the inner wall 400, and the arm 605 is advanced, to thereby move the cassette 410 and the transport device 600 to a prescribed position in the processing chamber 30. Next, the support section 601 and the cassette 410 are lowered by the elevating/lowering section 602 of the transport device 600. After the cassette 410 is placed on the installation base 420, the support section 601 is further lowered by the elevating/lowering section 602, to thereby separate the transport device 600 and the cassette 410 from each other. Thereafter, by retreating the arm 605, the transport device 600 is unloaded to outside of the processing chamber 30. Next, the processing chamber is air-tightly closed by the seal cap 110 (loading step).

Thereafter, inside of the processing chamber 30 is replaced with inert gas such as nitrogen gas (replacement step). After the atmosphere in the processing chamber 30 is replaced with the inert gas, in a normal temperature state, the selenium source such as H₂Se gas diluted to to 20% (preferably 2 to 20%) by the inert gas, is introduced from the gas supply tube 300. Next, the temperature is increased at a rate of 3 to 50° C. per minute, up to 400 to 550° C. and preferably 450° C. to 550° C. in a state that the selenium source is sealed, or in a state that a constant amount of the selenium source is flowed by exhausting the constant amount of the selenium source from the exhaust tube 310. The electric fan 500 is operated at this time, to thereby forcibly circulate the atmosphere in the processing chamber so that the gas flow is directed to the short-side direction of the glass substrate. After the temperature is increased to a prescribed temperature, this state is maintained for 10 to 180 minutes, preferably for 20 to 120 minutes, to thereby carrying out selenization treatment so that a light absorbing layer of the CIS-based solar battery is formed (formation step).

Thereafter, the inert gas is introduced from the gas supply tube 300, then the atmosphere in the processing chamber 30 is replaced, and the temperature is decreased to a prescribed temperature (temperature decreasing step). After the temperature is decreased to the prescribed temperature, the processing chamber 30 is opened by moving the seal cap 110. When the processing chamber 30 is opened, the wheel sections 603 are placed on the transport path of the inner wall 400, in a state that the support section 601 is lowered by the elevating/lowering section 602 of the transport device 600. Next, the arm 605 is advanced and the transport device 600 is moved to a prescribed position, and thereafter the support section 601 is elevated by the elevating/lowering section 602, to thereby lift the cassette 410. Then, the arm 605 is retreated and the cassette 410 is unloaded (unloading step), to thereby end a series of processing.

The invention according to the aforementioned first embodiment has at least one effect as will be described later.
(1) By flowing the gas in the processing chamber 30 in the short-side direction of the glass substrate, the uniformity of the temperature of the glass substrate can be maintained even if not increasing the flow velocity of the circulated gas compared with a case that the gas is flowed in the long-side direction of the glass substrate, and the size of the glass substrate can be increased.
(2) In (1), a plurality of electric fans are arranged in the long-side direction of the glass substrate. Therefore, uniformity of the gas flow in the long-side direction of the glass substrate can be realized.
(3) In (1) or (2), a pair of inner walls are provided so as to interpose the glass substrate between them. Therefore, the circulated gas flow can be efficiently directed to the glass substrate.
(4) In (3), the pair of inner walls are extended to the side face of the electric fan. Therefore, the gas flow can be efficiently directed to the glass substrate.
(5) In any one of (2) to (4), at least the blade section and the rotating section of the electric fan are coated with a substance with higher selenization resistance than the selenization resistance of the base of the blade section. Therefore, the base of the blade section requiring complicated processing by the metal material such as stainless, can be formed.
(6) In any one of (1) to (5), the reaction tube is made of the metal material such as stainless. Therefore, the size of the reaction tube can be increased, and the size of the glass substrate can be increased.
(7) In (6), at least the part of the reaction tube exposed to the atmosphere of the processing chamber, is coated with a substance with higher selenizaiton resistance than the selenization resistance of the base of the reaction tube. Therefore, the cost of the substrate processing apparatus can be reduced.
(8) In any one of (1) to (7), the rectifier having a plurality of opening parts are arranged on the upstream side in the flowing direction of the gas on the surfaces of the plurality of glass substrates. Therefore, the conductance of the gas flow can be adjusted. As a result, the gas flow forcibly circulated by the electric fan can be adjusted, and the uniformity of the gas flow can be realized.
(9) In (8), the numerical apertures of the opening parts of the rectifier are differentiated in the area immediately under the electric fan, and in the area between the electric fans. Therefore, disturbance of the gas flow due to the arrangement of the electric fan can be adjusted.
(10) In (8) and (9), the rectifier is also provided on the downstream side of the glass substrate. Therefore, the conductance of the gas can be further finely adjusted.
(11) The transport device for loading and unloading the cassette that holds a plurality of glass substrates into/from the processing chamber, has a plurality of wheel sections. Therefore, the cassette can be easily transported even when the sizes of the plurality of glass substrates are increased. In other words, a large-sized glass substrate can be realized.
(12) In (11), the elevating/lowering section for lifting the cassette is provided. Therefore, after the cassette is transported, the transport device can be taken out from the processing chamber.

### Second Embodiment

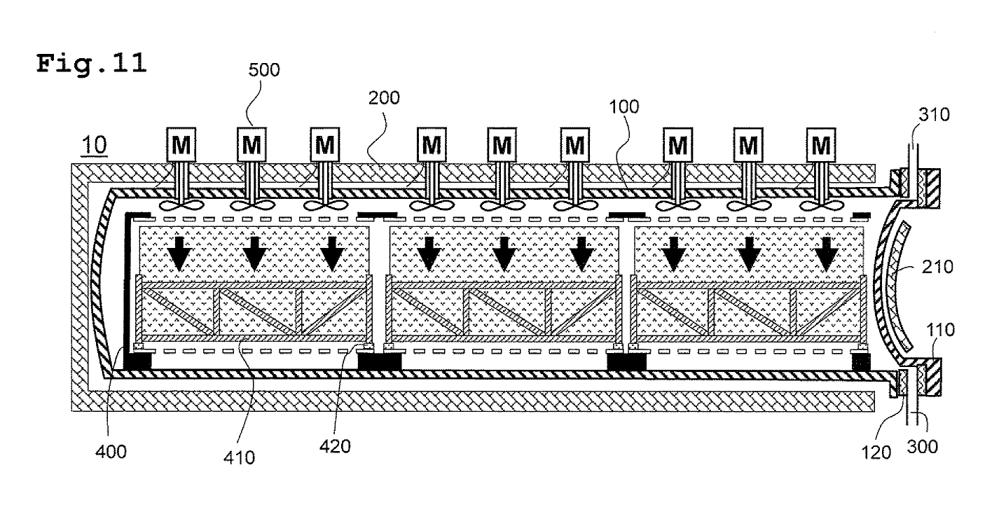

Other embodiment of the processing furnace 10 shown in FIG. 1 and FIG. 2 will be described next using FIG. 11. In FIG. 11, the same signs and numerals are assigned to the members having the same functions as those of FIG. 1 and FIG. 2. Here, a different point from the first embodiment will be mainly described.

In a second embodiment shown in FIG. 11, a different point is that a plurality of cassettes 410 (three in this embodiment) are arranged in a direction parallel to the surface of a plurality of glass substrates, unlike the first embodiment wherein only one cassette 410 that holds the plurality of glass substrates 20 is placed.

In the present invention, the atmosphere in the processing chamber 30 is forcibly circulated by the electric fan 500 in the short-side direction of the glass substrate 20. Therefore, the gas flow flowing on the surface of each glass substrate 20 is similar to the flow of the first embodiment, even if a plurality of cassettes 410 are arranged in the long-side direction of the glass substrate 20. Accordingly, a plurality of glass substrates can be arranged in the long-side direction, and the number of glass substrates that can be processed at once, can be increased.

Further, as is described in the first embodiment, in the present invention, the cassette 410 is transported into the processing chamber by the transport device 600 having the wheel sections 603. Accordingly, even if the cassettes 410 are sequentially arranged from a loading port as described in this embodiment, the cassette 410 can be transported a long way by adjusting a length of the arm 605.

Further, not a conventional quartz reaction tube, but the metal material such as stainless, is used as the base of the reaction tube 100. Accordingly, even if the size of the reaction tube 100 is increased, molding of the reaction tube is facilitated compared with the quartz reaction tube, and the increase of the cost is small compared with the cost of the quartz reaction tube. Therefore, the number of glass substrates 20 that can be processed at once, can be increased, and the manufacturing cost of the CIS-based solar battery can be reduced. Further, by using the metal material such as stainless as the base of the reaction tube, the reaction tube is easy to be handled compared with the quartz reaction tube, and the size of the reaction tube can be increased.

In the present invention according to the second embodiment, at least one of the following effects can be realized, in addition to the effects of the first embodiment.
(1) A plurality of cassettes 410 holding a plurality of glass substrates 20, can be arranged side by side in a direction parallel to the surfaces of the glass substrates 20. Therefore, the number of glass substrates that can be processed at once can be increased, and the manufacturing cost of the CIS-based solar battery can be reduced.

As described above, embodiments of the present invention have been described using the drawings. However, the embodiments can be variously modified in a range not departing from the gist of the present invention. For example, in the aforementioned embodiment, explanation has been given for the selenization treatment applied to a plurality of glass substrates composed of copper (Cu), indium (In), and gallium (Ga). However, the present invention is not limited thereto, and the selenization treatment may also be applied to a plurality of glass substrates composed of copper (Cu) /indium (In) and copper (Cu) /gallium (Ga). Further, this embodiment refers to the selenization treatment which is high in reactivity with the metal material. However, in a case of the CIS-based solar battery, instead of the selenization treatment, or after the selenization treatment, elemental sulfur-containing gas is supplied to carry out sulfidization treatment in some cases. At this time as well, the number of glass substrates capable of carrying out sulfidization treatment at once, can be increased by using a large-sized reaction furnace of this embodiment, and therefore reduction of the manufacturing cost can be realized.

Preferred main aspects of the present invention will be supplementarily described finally.
(1) There is provided a substrate processing apparatus, comprising:

a processing chamber configured to house a plurality of substrates with a laminated film which is composed of any one of copper-indium, copper-gallium, or copper-indium-gallium;

a reaction tube formed to constitute the processing chamber;

a gas supply tube configured to introduce elemental selenium-containing gas or elemental sulfur-containing gas to the processing chamber;

an exhaust tube configured to exhaust an atmosphere in the processing chamber;

a heating section provided so as to surround the reaction tube; and

a fan configured to forcibly circulate the atmosphere in the processing chamber in a short-side direction of the plurality of glass substrates, on surfaces of the plurality of glass substrates.

(2) There is provided the substrate processing apparatus according to the aforementioned (1), wherein a plurality of fans are arranged along a long-side direction of the substrates.
(3) There is provided the substrate processing apparatus according to the aforementioned (1) or (2), further comprising:

a pair of inner walls that extend in a long-side direction of the plurality of substrates and provided to interpose the plurality of substrates between them.
(4) There is provided the substrate processing apparatus according to the aforementioned (3), wherein the pair of inner walls are further provided to interpose the side face of the fan.
(5) There is provided the substrate processing apparatus according to any one of the aforementioned (2) to (4), wherein the fan has a blade section rotating in the processing chamber, and a base of the blade section is coated with a coating film mainly composed of a substance with higher selenization resistance or sulfidation resistance than a material of the base of the blade section.
(6) There is provided the substrate processing apparatus according to any one of the aforementioned (1) to (5), wherein a base of the reaction tube is made of a metal material.
(7) There is provided the substrate processing apparatus according to the aforementioned (6), wherein at least a part of the reaction tube exposed to an atmosphere in the processing chamber, is coated with a substance with higher selenization resistance or sulfidation resistance than a material of the base of reaction tube.
(8) There is provided the substrate processing apparatus according to any one of the aforementioned (1) to (7), further comprising a first rectifier having a plurality of opening parts on the upstream side of the plurality of substrates in a direction of flowing the elemental selenium-containing gas or the elemental sulfur-containing gas on the surfaces of the plurality of substrates.
(9) There is provided the substrate processing apparatus according to the aforementioned (8), comprising a second rectifier having a plurality of opening parts on the downstream side of the plurality of substrates in a direction of flowing the elemental selenium-containing gas or the elemental sulfur-containing gas on the surfaces of the plurality of substrates.
(10) There is provided the substrate processing apparatus according to the aforementioned (8) or (9), wherein a plurality of fans are provided in a long-side direction of the plurality of substrates, and a numerical aperture of each opening of an area immediately under the fans of the first rectifier, is different from the numerical aperture of each opening of an area between the fans.
(11) There is provided the substrate processing apparatus according to any one of the aforementioned (1) to (10), wherein the plurality of substrates are held by the cassette, and a plurality of cassettes are arranged in a long-side direction of the plurality of substrates.
(12) There is provided a transport device that transports a cassette holding a plurality of substrates, into a processing chamber, comprising:

a support section configured to support the cassette;

a wheel section fixed to the support section; and

an arm configured to integrally operate the support section and the wheel section.
(13) There is provided the transport device according to the aforementioned (12), wherein the transport device further comprises an elevating/lowering section provided between the support section and the wheel section in such a manner as being elevated and lowered.

What is claimed is:

1. A substrate processing apparatus, comprising:
a processing chamber configured to house a plurality of substrates with a laminated film which is composed of any one of copper-indium, copper-gallium, or copper-indium-gallium;
a reaction tube formed to constitute the processing chamber;
a gas supply tube configured to introduce elemental selenium-containing gas or elemental sulfur-containing gas to the processing chamber;
an exhaust tube configured to exhaust an atmosphere in the processing chamber;
a heating section provided to surround the reaction tube; and
a fan configured to forcibly circulate the atmosphere in the processing chamber in a short-side direction of the plurality of glass substrates, on surfaces of the plurality of glass substrates.

2. The substrate processing apparatus according to the claim 1, wherein a plurality of fans are arranged along a long-side direction of the substrates.

3. The substrate processing apparatus according to the claim 1, further comprising:
a pair of inner walls that extend in a long-side direction of the plurality of substrates and provided to interpose the plurality of substrates between them.

4. The substrate processing apparatus according to claim 3, wherein the pair of inner walls are further provided so as to interpose the side face of the fan.

5. The substrate processing apparatus according to claim 1, wherein the fan has a blade section rotating in the processing chamber, and a base of the blade section is coated with a coating film mainly composed of a substance with higher selenization resistance or sulfidation resistance than a material of the base of the blade section.

6. The substrate processing apparatus according to claim 1, wherein a base of the reaction tube is made of a metal material.

7. The substrate processing apparatus according to claim 6, wherein at least a part of the reaction tube exposed to an atmosphere in the processing chamber, is coated with a substance with higher selenization resistance or sulfidation resistance than a material of the base of reaction tube.

8. The substrate processing apparatus according to claim 1, comprising a first rectifier having a plurality of opening parts on the upstream side of the plurality of substrates in a direction of flowing the elemental selenium-containing gas or the elemental sulfur-containing gas on the surfaces of the plurality of substrates.

9. The substrate processing apparatus according to claim 8, comprising a second rectifier having a plurality of opening parts on the downstream side of the plurality of substrates in a direction of flowing the elemental selenium-containing gas or the elemental sulfur-containing gas on the surfaces of the plurality of substrates.

10. The substrate processing apparatus according to claim 8, wherein a plurality of fans are provided in a long-side direction of the plurality of substrates, and a numerical aperture of each opening of an area immediately under the fans of the first rectifier, is different from the numerical aperture of each opening of an area between the fans.

11. The substrate processing apparatus according to claim 1, wherein the plurality of substrates are held by the cassette, and a plurality of cassettes are arranged in a long-side direction of the plurality of substrates.

12. A transport device that transports a cassette holding a plurality of substrates, into a processing chamber, comprising:
a support section configured to support the cassette;
a wheel section fixed to the support section; and
an arm configured to integrally operate the support section and the wheel section.

13. The transport device according to claim 12, wherein the transport device further comprises an elevating/lowering section provided between the support section and the wheel section in such a manner as being elevated and lowered.
